(19) United States
(12) Patent Application Publication
(10) Pub. No.: US 2015/0248728 A1
(43) Pub. Date: Sep. 3, 2015

(54) SYSTEM AND METHODS FOR INTEGRATING INFORMATION TO FACILITATE COMPOSING TRADES

(71) Applicant: optionsXpress Holdings, Inc., Chicago, IL (US)

(72) Inventors: Amy Hoffman, Pacifica, CA (US); Gabe Morton-Cook, Chicago, IL (US)

(21) Appl. No.: 14/634,100

(22) Filed: Feb. 27, 2015

Related U.S. Application Data
(60) Provisional application No. 61/946,099, filed on Feb. 28, 2014.

(51) Int. Cl. G06Q 40/04

(52) U.S. Cl. CPC G06Q 40/04

(57) ABSTRACT

The invention includes a trade research component configured to store and display investing information, a trade parameter component configured to identify at least one or more trade parameter and a trade request form configured to permit entry of trade parameters of a trade order that the customer wishes or may wish to have executed in a forum. A graphical representation on a user interface comprises the integration of the components to provide information including trading workflow data, historical market data, and predictive market data for display in order to facilitate simplified research, preparation, and submission of trade orders to a forum.

### CROSS-REFERENCE TO RELATED APPLICATIONS

This application claims the benefit of U.S. Provisional Patent Application Ser. No. 61/946,099 filed Feb. 28, 2014.

### FIELD OF THE INVENTION

The invention relates generally to a system and methods for trading items. Certain embodiments of the invention include the integration of information including trading workflow data, historical market data, and predictive market data for display as a graphical representation on a user interface in order to facilitate simplified research, preparation, and submission of trade orders to a forum.

### BACKGROUND OF THE INVENTION

Certain institutions, such as financial institutions, facilitate trading of items among its customers or between its customers and other traders.

For purposes of this application, the term “trading” includes the transfer of any consideration in exchange for that which is the subject of the trade. The subject of the trade is termed an “item” in this application. An item may be anything of value including, for example, coins, stamps, books, objects of fine art, craftsmanship, and those having historical significance, and “financial securities”, among others. For purposes of this application, a “financial security” or “security” includes stocks, commodities, currencies, bonds, and derivatives such as futures, forwards, options, futures options, equities, and swaps.

Also for purposes of this application, a “customer” is any individual or entity that may or does engage in the trading of items whose value varies according to market perception. A customer is also referred to as an “investor” for purposes of this application. The invention has applications to all such items, including properties and securities that may be bought and sold in a generally open marketplace at a price that varies according to market perception. Certain embodiments of the invention will be described by reference to financial securities, but may be used with respect to any type of item.

Financial institutions have developed certain standardized sets of instruction forms for trading that may be easily transferred to and understood by it and other financial institutions. Using that standardized instruction form, an investor can prepare an instruction set and transfer it to a financial institution, for example, by telephone, by facsimile, by electronic mail, by a communication element of a system, by a data communication network, or by another means. The financial institution may evaluate the instructions for certain characteristics and may store the instructions for an appropriate period of time. If appropriate, the financial institution develops a “trading order” or “order”—that is, a set of instructions formatted and configured to be sent to a trading forum—from the instruction form. For purposes of this application, a “trading forum” or “forum” may include a financial security exchange, a group of exchanges, a market maker, auction house, liquidity pool, a department of the financial institution that provides the trading system, or any other entity that may execute a trade.

Certain standardized sets of trading instruction forms currently used by financial institutions are configured to be implemented using a data communication network such as the Internet. For example, a financial institution may make trade instruction forms viewable in an internet browser accessible via the Internet or other instruction form system. Such instruction forms often include many fields in which the customer can manually fill in their preferences or requirements for a trade. Each field may be used to enter one or more trade parameters.

Examples of fields in an instruction form include a stock identification field, stock price field, buy or sell field, and quantity field. To facilitate options trading strategies (in which the customer buys or sells the option to buy or sell an underlying asset—i.e., a security—at a certain price by a certain date) or futures trading strategies (in which the customer buys or sells the right to buy or sell an underlying asset at a later date), instruction forms also may include a call or put field configured to permit select whether the underlying asset may be bought or sold, a strike price field configured to permit a customer to enter the price at which the underlying asset may be bought or sold, an expiration field to designate when the offer to trade expires or when the option to buy or sell expires, execution field to designate when the trade will be done, and a “type of trade” field to designate whether the customer wishes to trade a stock, option, future, or other security. Other more complicated trading strategies may include additional fields configured to permit entry of additional instructions. Clearly such instruction forms can be detailed and possibly tedious to fill out manually.

To permit a customer to research information regarding certain stocks or other securities, certain financial institutions' systems also include separate research tools. A research tool may be configured to provide information to a customer about potential trades. For example, one research tool may be a graph indicating how a security has performed over a certain time period. Another research tool may include a chart illustrating predictions for how a security might perform in the future. Because such research tools are separate from one another, a customer will typically review one research tool, record or try to remember that which they learned from the research tool, navigate to a separate research tool, and compare the information of both research tools.

In addition, because such research tools are separate from the instruction forms, a customer will typically review the research tool, record or try to remember that which they learned from the research tool, navigate to a separate instruction form, and enter instructions regarding a desired trade. Because so many discrete steps are required, the customer may make mistakes inputting the correct details regarding the desired trade. Also, customers may be frustrated with the time-consuming process.

Clearly, there is a demand for a system and methods for integrating information from research tools for display as a graphical representation on a user interface in order to facilitate simplified research, preparation, and submission of trade orders to a forum in addition to automatically inputting trade parameters into an instruction form integrated with one or more research tools, thereby simplifying the research and trade input process. The invention satisfies this demand.

### SUMMARY OF THE INVENTION

Certain embodiments of the invention include a trade research component, a trade parameter component, and a trade request component.

A trade research component may be configured to store and display investing information, otherwise referred to as trade parameters. For purposes of this application, investing information may include facts, figures, trends, predictions, opinions, observations, or other data regarding a security, company, person, or other entity that may affect the trading market. Investing information also may include trading strategies (e.g., more generally: neutral market strategies, bullish market strategies, or bearish market strategies, or, more specifically: straddle, spreads, going long, going short, reversal, conversion, butterfly, condor, collar, to name a few) or trading proposals (e.g., buy or sell a specific security, buy or sell a specific security for a specific price, or buy or sell a specific security at one of a number of price alternatives).

In certain embodiments, the trade research component may include one or more graphical representations. Generally, a graphical representation may include a graph (e.g., bar graph, area graph, line graph, pie graph, picture graph, scatter plot, histogram, or infographic) or a chart (e.g., table, timeline, or map).

More specifically, graphical representations may include a past performance element—which is configured specifically to convey investing information regarding how certain (one or more) securities have performed in the past—and a predicted performance element—which is configured to convey investing information regarding how such (one or more) securities may perform in the future.

Performance elements may be generated based on a specific pricing model. Examples of pricing models include rational pricing, moneyness, option time value and put-call parity. Some pricing models which may incorporate the first set of examples include Black-Scholes and the Black model, Binomial options pricing model, Monte Carlo option model, Finite difference methods for option pricing, Heston model, Heath-Jarrow-Morton framework, and Variance gamma model.

As indicated above, certain embodiments of the invention also include a trade parameter component, which may be configured to identify at least one or more trade parameter in any form and may be integrated with the trade research component. In certain embodiments, a trade parameter component is configured as an actionable trade indicator such that a customer may activate the indicator via a user interface of a display device, for example, by clicking or hovering a mouse pointer, tapping a touchscreen, depressing one or more keys on a keyboard, voice-activation, or other peripheral computer device method.

After the consumer selects the actionable trade indicator, one or more action responses may occur. In certain embodiments, selecting the actionable trade indicator causes one or more trade parameters to appear such as in a particular form on the user interface, for example a Greeks book form or a trade request form presented on the user interface. In certain embodiments, a trade request form may be located and sized (e.g., minimized) such that at least a portion of or the entire trade research component is displayed in the display unit such that only a portion of or no portion of the trade research component is blocked by the trade request form.

A trade request form may include certain input fields configured to permit entry of parameters of a trade that the customer wishes or may wish to have executed. One or more input fields may be automatically populated in the trade request form as a result of the customer's choice of the actionable trade indicator.

Certain actionable trade indicators may correspond to automatically populating the trade parameter of one or more of buy vs. sell, stock identification, underlying asset identification, strike price, expiration date, execution date, or any other trade parameter in the trade request form.

In certain embodiments, every input field in the trade request form is automatically populated based on the choice of the actionable trade indicator, while in other embodiments, only one or some of the input fields is automatically populated based on the choice of the actionable trade indicator. In the latter embodiments, the consumer may manually enter the empty input fields or import the relevant information to the empty input fields from saved examples or already-executed trade requests.

Also, the automatically populated input fields may be manually updated or changed by the consumer. Manual entry or updating of the input fields may be done by picking an item from a drop-down menu, checking a box, highlighting text, ranking available choices, clicking or hovering with a mouse, tapping in a touchscreen, depressing one or more keys on a keyboard, voice-activation, or other method known in the art.

When the input fields are filled in, the consumer may select a navigational indicator configured to signal and the consumer wishes to proceed to the subsequent phase. The subsequent phases may include showing a review screen such that the consumer may review the contents of the trade request, sending the trade request to a trading forum, and/or confirming that the trade request was sent to a trading forum.

One object of certain embodiments of the invention is to permit a consumer to research a trade and prepare a corresponding trade request more efficiently.

Another object of certain embodiments of the invention is to permit a consumer to view investing information simultaneously with a trade request form.

Another object of certain embodiments of the invention is to integrate and display a plurality of investing information such as that from various research tools in easy-to-understand graphical representations.

Another object of certain embodiments of the invention is to integrate educational and implementation steps of trading.

Another object of certain embodiments of the invention is to permit a consumer to more quickly implement trade requests according to a proposed strategy.

Another object of certain embodiments of the invention is to permit a consumer to more quickly and easily enter trade parameters into a trade request form by facilitating automatic population of certain input fields of the trade request form based on the selection of an actionable trade indicator.

Another object of certain embodiments of the invention is to permit a consumer to more easily update entered trade parameters in a trade request form by facilitating the change of automatically populated input fields of the trade request form.

Another object of certain embodiments of the invention is to permit a consumer to more easily visualize relationships between pricing model projections and available trades or trade parameters of available trades.

The invention and its attributes and advantages will be further understood and appreciated with reference to the detailed description below of presently contemplated embodiments, taken in conjunction with the accompanying drawings.

### BRIEF DESCRIPTION OF THE DRAWINGS

The preferred embodiments of the invention will be described in conjunction with the appended drawings provided to illustrate and not to the limit the invention, where like designations denote like elements, and in which:

FIG. 1 illustrates a block diagram of an embodiment of a system user interface including a trade research component, trade parameter component, and a trade request component according to the invention;

FIG. 2 illustrates a block diagram of an embodiment of a system user interface of the trade research component according to the invention;

FIG. 3 illustrates a graphical user interface of an embodiment of the trade research component according to the invention;

FIG. 4 illustrates a graphical user interface of an embodiment of the trade research component including trade parameter component according to the invention;

FIG. 5 illustrates a graphical user interface of an embodiment of the trade research component including trade request component according to the invention;

FIG. 6 illustrates another embodiment of a graphical user interface according to the invention;

FIG. 7 illustrates yet another embodiment of a graphical user interface according to the invention;

FIG. 8 illustrates still another embodiment of a graphical user interface according to the invention;

FIG. 9 illustrates a flow chart of a method according to one embodiment of the invention;

FIG. 10 is a block diagram illustrating an example of a computing device that may implement one or more methods of the invention; and

FIG. 11 illustrates a cloud computing embodiment of a computer system according to the invention.

### DETAILED DESCRIPTION OF EMBODIMENTS OF THE INVENTION

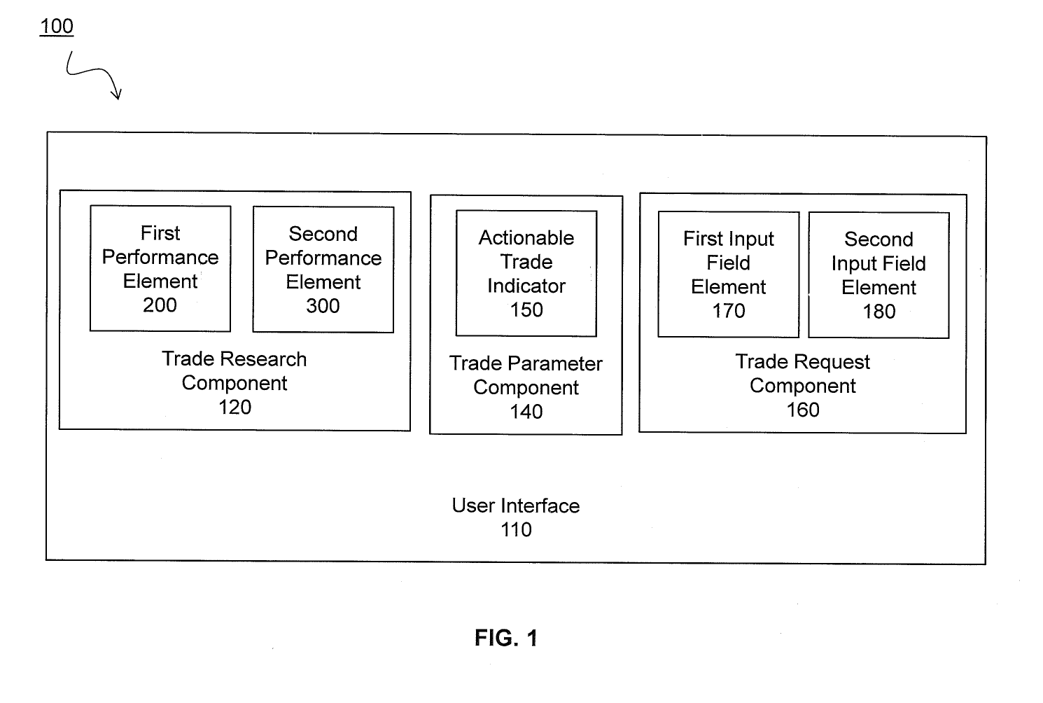

Certain embodiments of the invention include a trade research component 120 and a trade parameter component 140 displayed on a user interface 110 of a system 100 as illustrated in FIG. 1. As illustrated in FIG. 1, certain embodiments of the invention also may include a trade request component 160.

In certain embodiments, the trade research component 120 may include a graphical representation, such as a first performance element 200 configured to display investing information about past performance of a security in addition to a second performance element 300 configured to display investing information about future performance of the security. The first performance element 200 is configured specifically to display investing information regarding how certain (one or more) securities have performed in the past. The second performance element 300 is configured to display investing information regarding how such (one or more) securities may perform in the future.

Performance elements 200, 300 may be generated based on a specific pricing model. Examples of pricing models include rational pricing, moneyness, option time value and put-call parity. Some pricing models which may incorporate the first set of examples include Black-Scholes and the Black model, Binomial options pricing model, Monte Carlo option model, Finite difference methods for option pricing, Heston model, Heath-Jarrow-Morton framework, and Variance gamma model. In certain embodiments, the consumer may choose which pricing model is used to generate the graphical representation, may switch between multiple pricing models at different times, or may opt for displaying one or more performance graphical representation simultaneously, wherein each performance graphical representation is generated using a different pricing model.

As indicated above, certain embodiments of the invention also include a trade parameter component 140, which may be configured to identify at least one or more trade parameter and may be generally integrated with the trade research component 120.

In certain embodiments, the trade parameter component 140 is configured as an actionable trade indicator 150 such that a customer may activate the actionable trade indicator 150 via a user interface 110, for example, by clicking or hovering a mouse pointer, tapping a touchscreen, depressing one or more keys on a keyboard, voice-activation, or other peripheral computer device method.

As illustrated in FIG. 1, certain embodiments of the invention also may include a trade request component 160, which may be configured to identify at least one or more trade parameter more specifically directed to a trade order and may be generally integrated with the trade research component 120 and trade parameter component 140.

The trade request component 160 may be a form including certain input field elements 170, 180 configured to permit entry of trade parameters that the customer wishes or may wish to have executed. Although FIG. 1 illustrates two field elements, any number of elements are contemplated. One or more input field elements 170, 180 may be automatically populated in the trade request form as a result of the customer's choice of the actionable trade indicator 150. For example, certain actionable trade indicators 150 may correspond to automatically populating the trade parameter of one or more of buy vs. sell, stock identification, underlying asset identification, strike price, expiration date, execution date, or any other trade parameter in the trade request component 160.

In certain embodiments, every input field element 170, 180 in the trade request component 160 is automatically populated based on the choice of the actionable trade indicator 150, while in other embodiments, only one or some of the input fields 170, 180 are automatically populated based on the choice of the actionable trade indicator 150. In the latter embodiments, the system may receive information manually entered by an investor into the input field elements 170, 180 or import the relevant information from saved examples or already-executed trade requests.

It is also contemplated that the automatically populated input field elements 170, 180 may be manually updated or changed by the consumer. Manual entry or updating of the input field elements 170, 180 may be done by picking an item from a drop-down menu, checking a box, highlighting text, ranking available choices, clicking or hovering with a mouse, tapping in a touchscreen, depressing one or more keys on a keyboard, voice-activation, or other method known in the art.

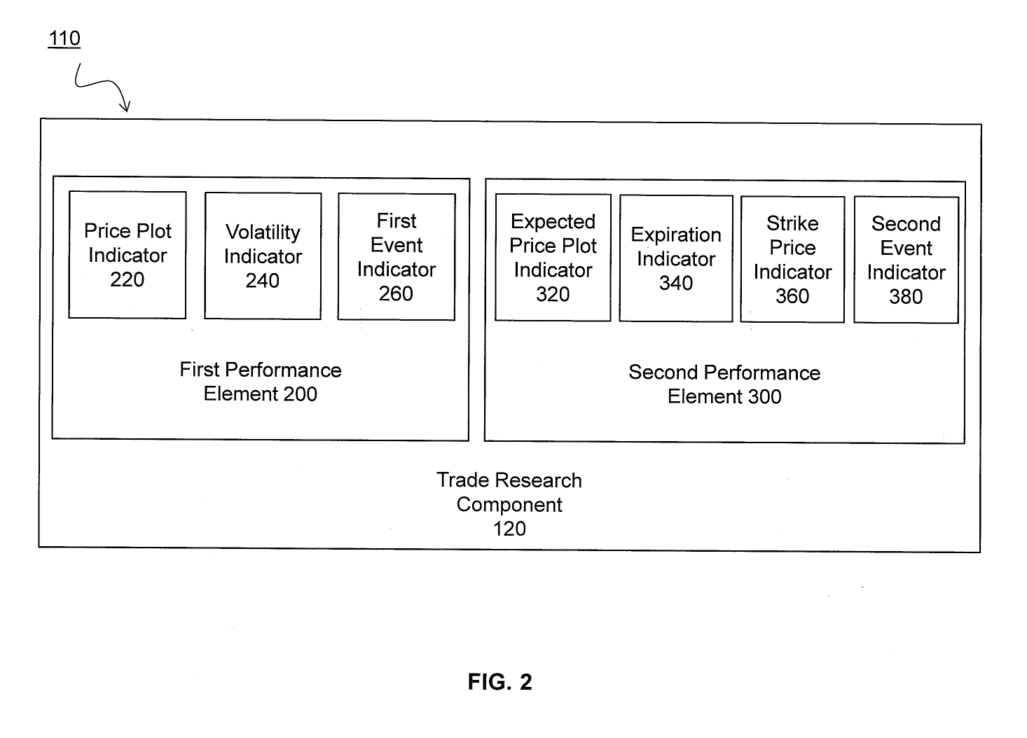

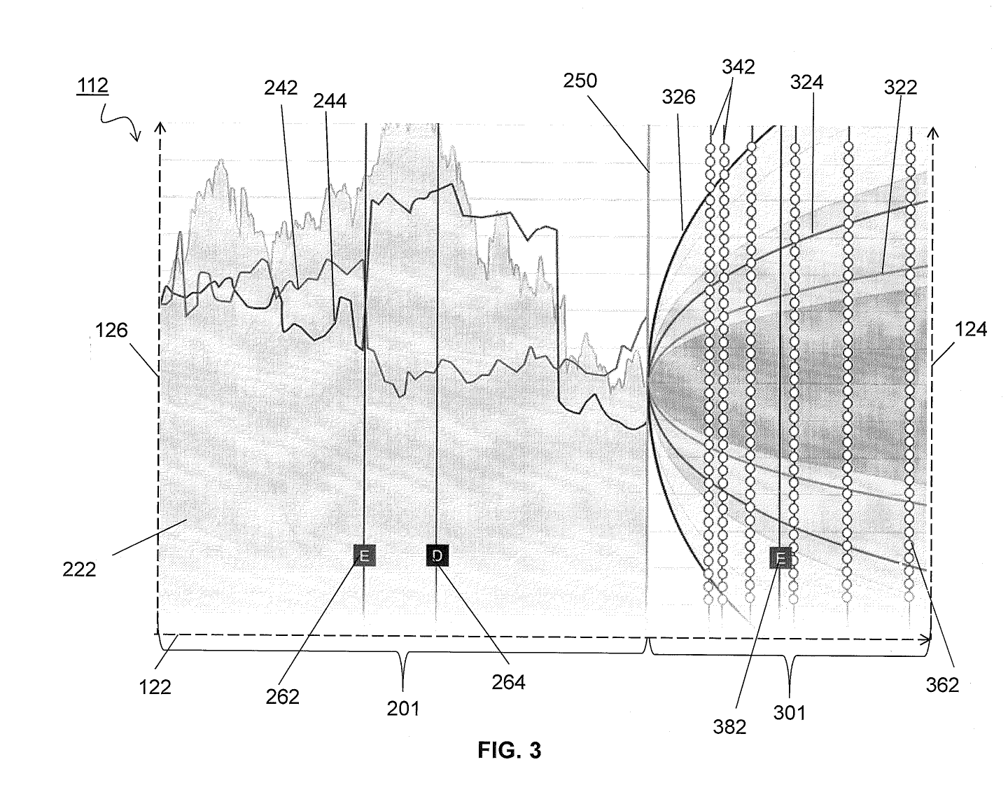

FIG. 2 illustrates a block diagram of an embodiment of a system user interface 110 of the trade research component 120 according to the invention. In certain embodiments, the trade research component 120 may be represented as a graphical user interface 112 as shown in FIG. 3.

The trade research component 120 includes a first performance element 200 configured to display investing information about past performance of a security in addition to a second performance element 300 configured to display investing information about future performance of the security.

The past performance content 201 and future performance content 301 is shown on the graphical user interface 112 in FIG. 3 divided by a time dividing line 250. The time dividing line 250 is configured to represent “now” on a time scale 122. More specifically, the graphical user interface 112 includes the time scale 122 on an x-axis and a price scale 124, percentage scale 126 on a y-axis. The percentage scale 126 corresponds with the past performance content 201 and the price scale 124 corresponds with the predicted performance content 301.

Turning back to FIG. 2, the first performance element 200 includes a price plot indicator 220, a volatility indicator 240, and a first event indicator 260. The price plot indicator 220 represents the price of the item such as an underlying instrument—stock, exchange traded fund (ETF), futures—across a range of time. Data is gathered with respect to the price of the item at a plurality of times within a range of time in order to transform the data into a plot of the price of the item at each time in the plurality of times. As shown in FIG. 3, the plot 222 represents the price of the item at various times.

The volatility indicator 240 represents the extent to which the return of the underlying asset will fluctuate between now and at expiration. Volatility, as expressed as a percentage coefficient within option-pricing formulas, arises from daily trading activities. The data may enable an investor to gather how current options pricing is being determined, and compare this to the historical figures.

Data is gathered with respect to the implied volatility and historic volatility of the item at a plurality of times within a range of time in order to transform the data into a line graph of the volatility of the item at each time in the plurality of times. As shown on FIG. 3, the line graph 242 represents the implied volatility of the item at various times and the line graph 244 represents the historic volatility of the item at various times.

In certain embodiments of the invention, the first event indicator 260 of the first performance element 200 may be earning and dividend events that occurred in the past. Data is gathered at a plurality of times within a range of time in order to transform the data into a vertical line representing the time an earning or a dividend is realized. As shown in FIG. 3, the vertical line 262 represents an earning event and the vertical line 264 represents a dividend event for the item at particular times. As shown in FIG. 3, the vertical lines 262, 264 also include an icon, specifically a letter icon ‘E’ and a letter icon ‘D’ to identify the event as either an earning event or a dividend event, respectively.

Turning back to FIG. 2, the second performance element 300 includes an expected price plot indicator 320, an expiration indicator 340, a strike price indicator 360, and a second event indicator 380. The expected price plot indicator 320 represents the predicted future price of instrument—stock, ETF, futures—across a range of future time. Data is measured with respect to the standard price deviation of the item at a plurality of future times within a range of time. The data measuring a first standard deviation, a second standard deviation and a third standard deviation is transformed into log-normal curve plots of the predicted price of the item over a period of future time.

As shown in FIG. 3, the first standard deviation is shown as a first log-normal curve plot 322, a second standard deviation is shown as a second log-normal curve plot 324, and a third standard deviation is shown as a third log-normal curve plot 326, each plot representing the expected price distribution over a period of time.

The expiration indicator 340 represents the expiration of the item, specifically an expiration date of an option. Data is gathered with respect to the expiration of each option. The data is transformed into one or more vertical lines 342 located on the graphical user interface 112 at the expiration date or specific time each option expires as shown in FIG. 3.

The strike price indicator 360 of FIG. 2 represents the one or more strike prices for an option. Data is gathered with respect to each strike price for each option and the data is transformed into one or more circle shapes 362 as shown in FIG. 3. Each circle shape 362 is located on the vertical line 342 representing the expiration date of the option. In FIG. 3, each circle shape 362 conveys a strike price across the expiration date of the option.

In certain embodiments of the invention, the second event indicator 380 shown in FIG. 2 of the second performance element 300 may be earning and dividend events expected to occur in the future. Data is calculated and transformed into a vertical line representing the time an earning or a dividend is expected to occur.

According to FIG. 3, the vertical line 382 represents a potential future earning event, however it is contemplated that the vertical line 382 may represent a dividend event for the item at particular times in the future. As shown in FIG. 3, the vertical line 382 also includes an icon, specifically a letter icon ‘E’ to identify the event as an earning event. However, as described above, the icon may be a letter icon ‘D’ to identify the event as a dividend event.

The indicators described—e.g., actionable trade indicators 150, price plot indicator 220, volatility indicator 240, first event indicator 260, expected price plot indicator 320, expiration indicator 340, strike price indicator 360, second event indicator 380—may be configured as generally any size, any shape, any style including for example round elements, tag elements, box elements, button elements, etc. Indicators also may be configured to convey information by its characteristics (e.g., character, color, shading, size, shape, width, compound lines, dashed lines, dotted lines, etc.), wherein each style alternative is associated with a certain meaning. It is also contemplated that any indicator may illustrate one or more trade parameters upon activation.

As previously mentioned, certain embodiments of the invention also include a trade parameter component 140 as shown in FIG. 1, which may be configured to identify at least one or more trade parameter and may be generally integrated with the trade research component 120 and trade request component 160. In certain embodiments, a trade parameter component 140 is configured as an actionable trade indicator 150 such that a customer may activate the actionable trade indicator 150 via a user interface 110, for example, by clicking or hovering a mouse pointer, tapping a touchscreen, depressing one or more keys on a keyboard, voice-activation, or other peripheral computer device method.

For purposes of this application, the one or more trade parameter may be any investing information as specified above in addition to any data related to the trade including, but not limited to, stock identification, underlying asset identification, strike price, expiration date, execution date, quantity, ask price, previous close, high, low, volume, option positions (i.e., delta, gamma, vega, theta), potential profit/loss, trading strategy, or any factor related to a security, which may include strike price, value price, historical volatility, implied volatility, underlying asset, entity earnings (e.g., quarterly earnings), expiration date of option/future contract, long positions, short positions, government regulations or actions, or other market information. Again, the one or more trade parameter may be any information or data related to the trade.

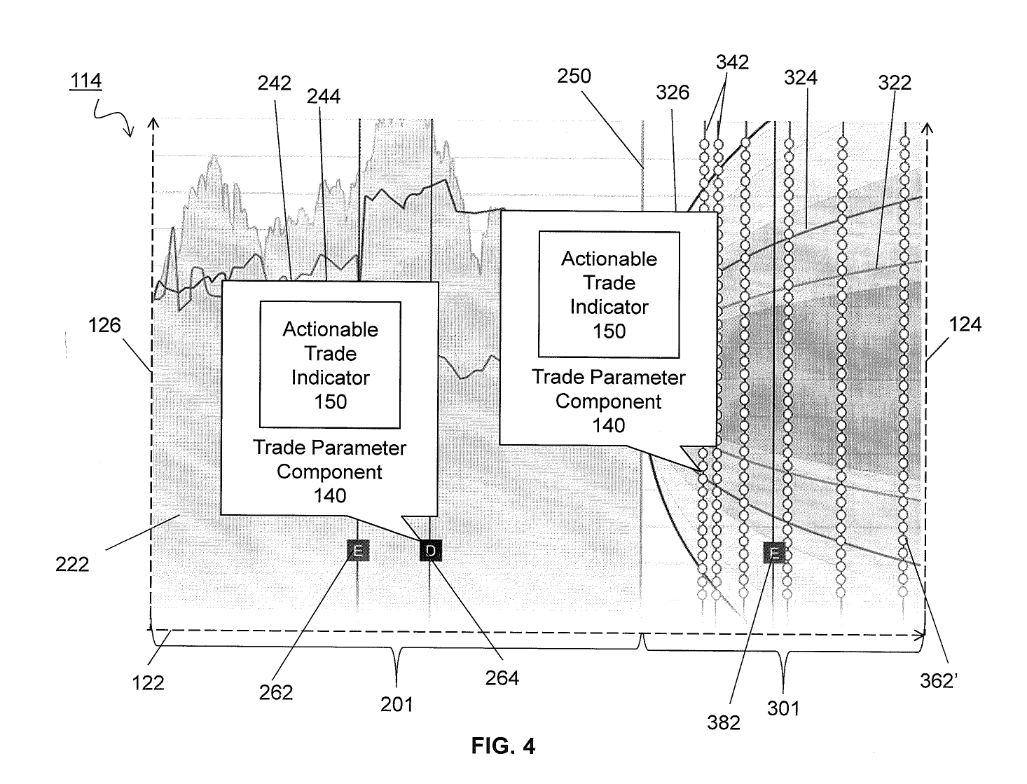

FIG. 4 illustrates a graphical user interface 114 of an embodiment of the trade research component 120 including trade parameter component 140 according to the invention. In certain embodiments, selecting the actionable trade indicator 150 causes one or more trade parameters to appear. In certain embodiments the one or more trade parameters are presented in a form including , for example, Greeks book form or a trade request form.

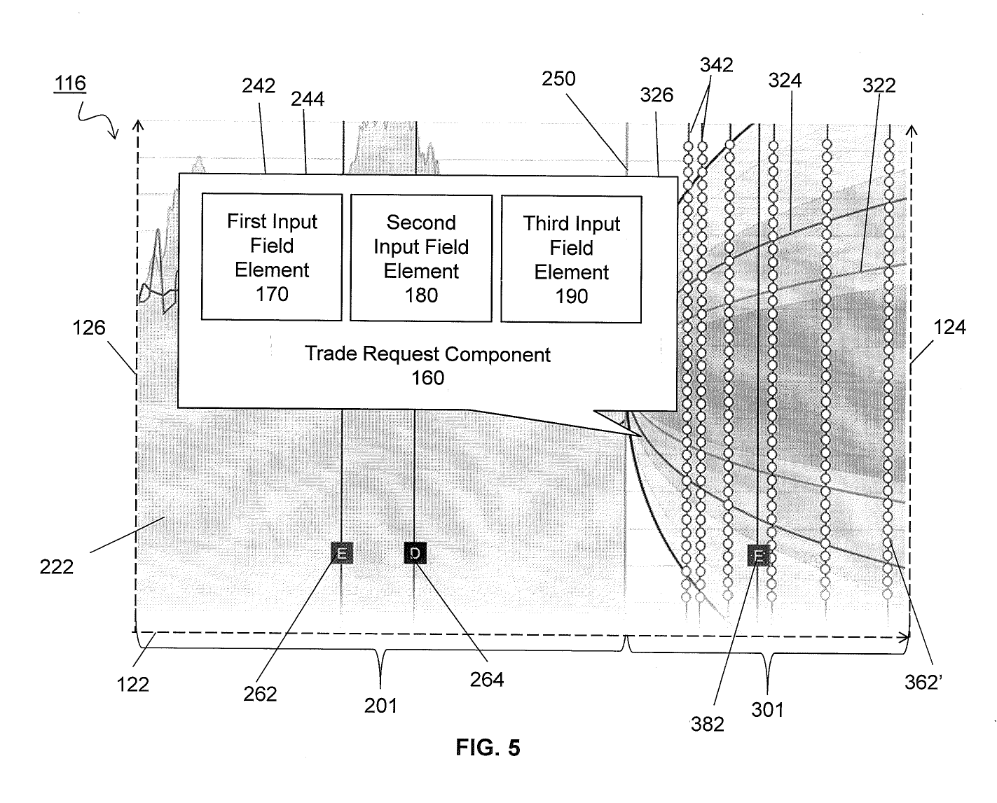

FIG. 5 illustrates a graphical user interface 116 of an embodiment of the trade research component 120 including trade request component 160 according to the invention. The trade request component 160 may be a form including certain input field elements 170, 180, 190 configured to permit entry of parameters of a trade that the customer wishes or may wish to have executed. Although FIG. 5 illustrates three field elements, any number of elements are contemplated. One or more input field elements 170, 180, 190 may be automatically populated in the trade request form as a result of the customer's choice of the actionable trade indicator 150. For example, an actionable trade indicator 150 may correspond to automatically populating the trade parameter of one or more of buy vs. sell, stock identification, underlying asset identification, strike price, expiration date, execution date, or any other trade parameter in the trade request component 160. In certain embodiments, the trade request component 160 may be positioned and sized (e.g., minimized) such that at least a portion of or the entirety of any performance content 201, 301 is displayed in the display unit and, accordingly, only a portion of or no portion of the any performance element 201, 301 is blocked by the trade request component 160.

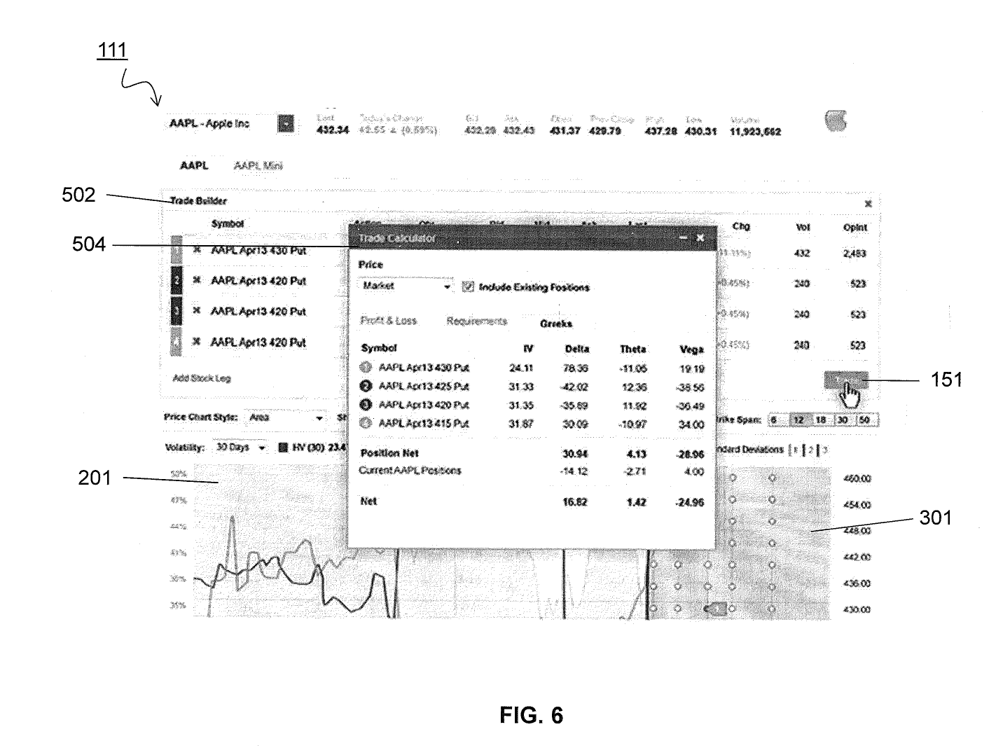

FIG. 6 illustrates another embodiment of a graphical user interface 111 according to the invention. In addition to past performance content 201 and future performance content 301, the graphical user interface 111 includes a trade request component 160 shown in FIG. 6 as a trade builder form 502. Before submitting a trade order, the consumer may wish to access more detailed information about the trade parameters or other investing information. Shown in FIG. 6, the actionable trade indicator 150 is a trade button 151 that upon activation is configured to show a plurality of trade parameters in the form of a trade calculator 504.

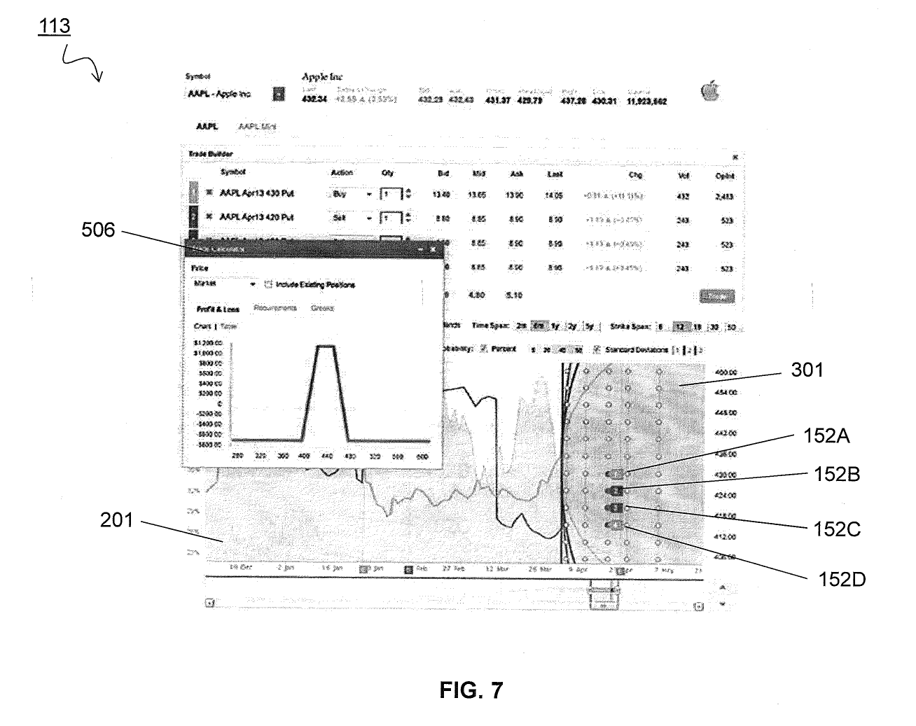

FIG. 7 illustrates yet another embodiment of a graphical user interface 113 according to the invention. As shown in this embodiment, the graphical user interface 113 includes actionable trade indicators 150 that are in the form of tag elements 152A-D indicating an investor's selection as a buy or a sell for the option at the strike price. Upon activation of a first tag element 152A, a plurality of trade parameters are illustrated in the form of a profit/loss chart 506. An investor may wish to build a strategy by choosing another strike price as a buy or a sell such that activation of a second tag element 152B updates real-time to illustrate a profit/loss chart 506 according to the two leg strategy. Similarly, selection of a third and fourth option for a buy or a sell at certain strike prices updates real-time to illustrate a profit/loss chart 506 according to a three leg strategy and four leg strategy, respectively. Although FIG. 7 illustrates up to and including a four leg strategy, any number of legs is contemplated.

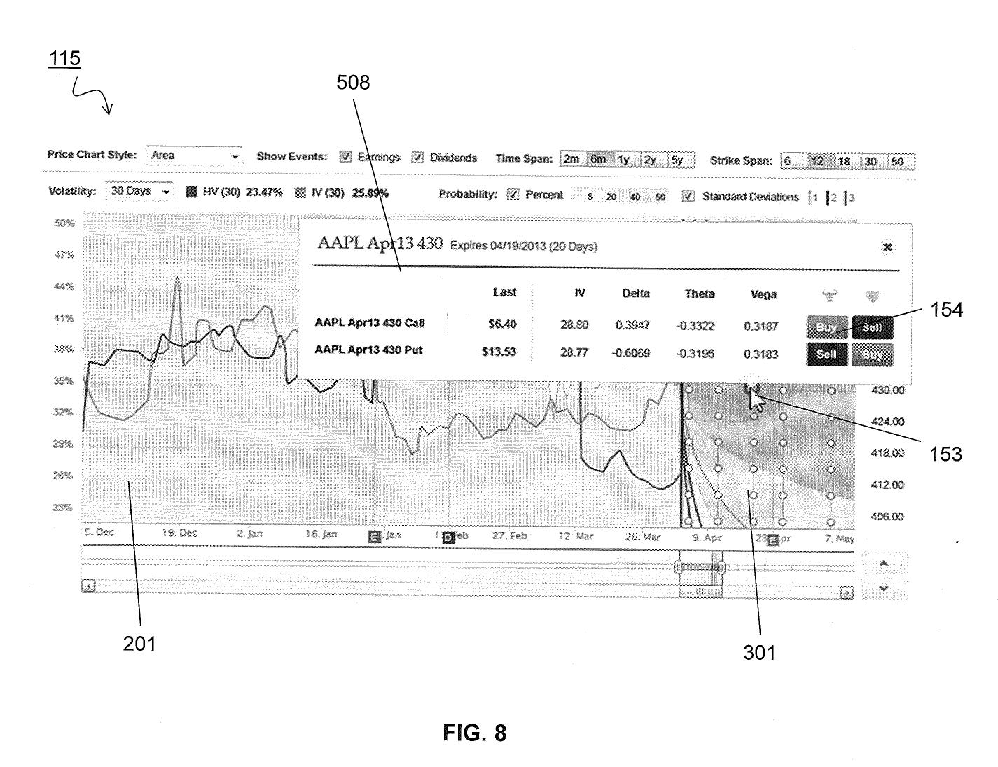

FIG. 8 illustrates still another embodiment of a graphical user interface 115 according to the invention. As shown in this embodiment, the graphical user interface 115 includes actionable trade indicators 150 that are in the form of circle elements 153. Upon activation of a circle element 153, a plurality of trade parameters are illustrated in the form of an option Greeks book form 508. An investor may wish to build a strategy by choosing an actionable trade indicator 150 from within the Greeks book form 508. As shown in FIG. 8, the Greeks book form 508 includes an actionable trade indicator 150 that is a button element 154 directed to a buy or a sell such that activation of the button element 154 initiates the preparation and submission of trade orders to a forum.

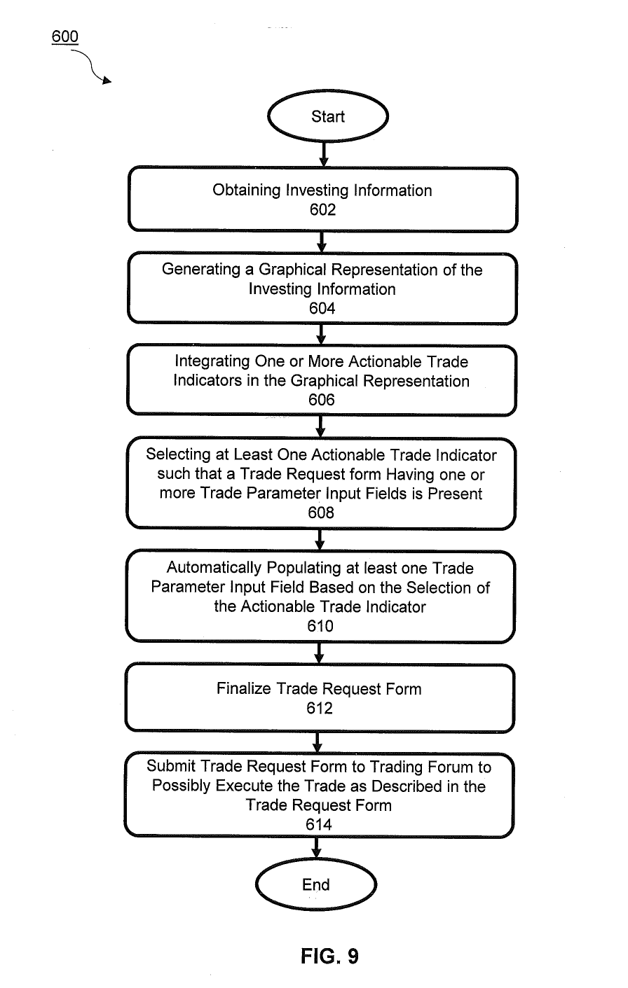

FIG. 9 illustrates a flow chart of a method according to one embodiment of the invention. In certain embodiments, investing information is obtained 602 and, from that information, a graphical representation configured to convey information regarding the investing information is generated 604. An actionable trade indicator is integrated into the graphical representation 606. Upon selecting the actionable trade indicator, a trade request form having one or more input fields configured to receive information regarding trade parameters is presented via a display unit 608. At least one input field is automatically populated based on the selection of the actionable trade indicator 610. A consumer may then finalize a trade request form 612 and submit such trade request form to a forum to possibly execute the trade described in the trade request form 614.

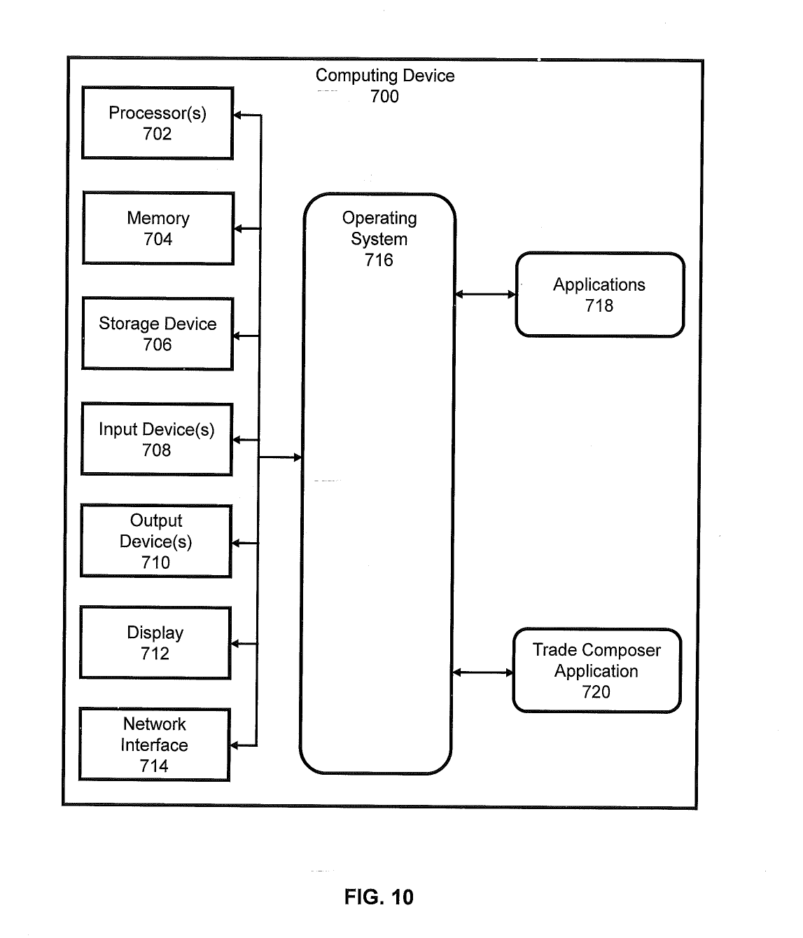

FIG. 10 is a block diagram illustrating an example of a computing device 700 that may implement one or more techniques of this invention. Computing device 700 is an example of a system that may be configured to transmit data to and receive data from communication network and execute one or more applications 718 (e.g., trade composer application 720). Computing device 700 may include or be part of a portable computing device (e.g., a mobile phone, netbook, laptop, personal data assistant (PDA), or tablet device, smart hand-held computing device, or a laptop or netbook computer, hand held console or MP3 player, tablet, or similar hand held device, such as an iPad®, iPad Touch® or iPhone®) or a stationary computer (e.g., a desktop computer, or set-top box), or may be another computing device. Computing device 700 includes processor(s) 702, memory 704, storage device 706, input device(s) 708, output device(s) 710, display 712, and network interface 714. Each of processor(s) 702, memory 704, storage device 706, input device(s) 708, output device(s) 710, display 712, and network interface 714 may be interconnected (physically, communicatively, and/or operatively) for inter-component communications. Operating system 716, applications 718, and trade composer application 720 may be executable by computing device 700. It should be noted that although example computing device 700 is illustrated as having distinct functional blocks, such an illustration is for descriptive purposes and does not limit computing device 700 to particular hardware architecture. Functions of computing device 700 may be realized using any combination of hardware, firmware and/or software implementations.

Processor(s) 702 may be configured to implement functionality and/or process instructions for execution in computing device 700. Processor(s) 702 may be capable of retrieving and processing instructions, code, and/or data structures for implementing one or more of the techniques described herein. Instructions may be stored on a computer readable medium, such as memory 704 or storage device 706. Processor(s) 702 may be digital signal processors (DSPs), general purpose microprocessors, application specific integrated circuits (ASICs), field programmable logic arrays (FPGAs), or other equivalent integrated or discrete logic circuitry.

Memory 704 may be configured to store information that may be used by computing device 700 during operation. As described above, memory 704 may be used to store program instructions for execution by processor(s) 702 and may be used by software or applications running on computing device 700 to temporarily store information during program execution. For example, memory 704 may store instructions associated with operating system 716, applications 718, and trade composer application 720 or components thereof, and/or memory 704 may store information associated with the execution of operating system 716, applications 718, and trade composer application 720. Memory 704 may be described as a non-transitory or tangible computer-readable storage medium. In some examples, memory 704 may provide temporary memory and/or long-term storage. In some examples, memory 704 or portion thereof may be described as volatile memory, i.e., in some cases memory 704 may not maintain stored contents when computing device 700 is powered down. Examples of volatile memories include random access memories (RAM), dynamic random access memories (DRAM), and static random access memories (SRAM).

Storage device 706 represents memory of computing device that may be configured to store relatively larger amounts of information for relatively longer periods of time than memory 704. Similar to memory 704, storage device 706 may also include one or more non-transitory or tangible computer-readable storage media. Storage device 706 may be internal or external memory and in some examples may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

Input device(s) 708 may be configured to receive input from an investor operating computing device 700. Input from an investor may be generated as part of an investor running one or more software applications, such as applications 718 and/or trade composer application 720. Input device(s) 708 may include a touch-sensitive screen, track pad, track point, mouse, a keyboard, a microphone, video camera, or any other type of device configured to receive input from an investor. In one example, input device(s) 708 may generate one or more signals corresponding to the coordinates of a position touched on a touchscreen of computing device 700. These signals may be provided as information to components of computing device 700 (e.g., processor 702, or operating system 716) in conjunction with the execution of applications 718 and/or trade composer application 720.

Output device(s) 710 may be configured to provide output to an investor operating computing device 700. Output may tactile, audio, or visual output generated as part of an investor running one or more software applications, such as applications 718 and/or trade composer application 720. Output device(s) 710 may include a touch-sensitive screen, sound card, a video graphics adapter card, or any other type of device for converting a signal into an appropriate form understandable to humans or machines. Additional examples of an output device(s) 710 may include a speaker, a cathode ray tube (CRT) monitor, a liquid crystal display (LCD), or any other, type of device that can provide output to an investor. In some examples, output device(s) 710 may be external to computing device 700 and may be operatively coupled to computing device 700 using a standardized communication protocol, such as for example, Universal Serial Bus protocol (USB) or High-Definition Multimedia Interface (HDMI).

In the example illustrated in FIG. 10, computing device 700 includes display 712. In the example where computing device 700 is a mobile device, display 712 may be an integrated touch-screen display. For example, display 712 may be an LCD or organic light emitting diode (OLED) display configured to receive user touch inputs, such as, for example, taps, drags, and pinches. Thus, display 712 may be considered as a particular type of input and output device of computing device 700. Display 712 may be configured to allow an investor to interact with the trade composer application 720, as describe in detail below.

Network interface 714 may be configured to enable computing device 700 to communicate with external devices via one or more networks, such as communications network 104. Network interface 714 may be a network interface card, such as an Ethernet card, an optical transceiver, a radio frequency transceiver, or any other type of device that can send and receive information. Network interface 714 may be configured to operate according to one or more of the communication protocols described above with respect to communications network 104.

Operating system 716 may be configured facilitate the interaction of applications, such as application 718 and trade composer application 720, with processor(s) 702, memory 704, storage device 706, input device(s) 708, output device(s) 710, display 712, network interface 714 and other hardware components of computing device 700. Operating system 716 may be an operating system designed to be installed on laptops and desktops. For example, operating system 716 may be a Windows operating system, Linux, or Mac OS. In another example, if computing device 700 is a mobile device, such as a smartphone or a tablet, operating system 716 may be one of Android, iOS or a Windows mobile operating system.

Applications 718 may be any applications implemented within or executed by computing device 700 and may be implemented or contained within, operable by, executed by, and/or be operatively/communicatively coupled to components of computing device 700, e.g., processor(s) 702, memory 704, and network interface 714. In one example, an application may be developed by developer site 106 as described above with respect to FIG. 10. Applications 718 may include instructions that may cause processor(s) 702 of computing device 700 to perform particular functions. Applications 718 may include algorithms which are expressed in computer programming statements, such as, for loops, while-loops, if-statements, do-loops, etc.

Computer programs, when executed, enable the computing device 700, particularly the processor 702, to implement the methods of the invention according to computer software including instructions.

The computing device 700described herein may perform any one of, or any combination of, the steps of any of the methods presented herein. It is also contemplated that the methods according to the invention may be performed automatically.

The computing device 700 of FIG. 10 is provided only for purposes of illustration, such that the invention is not limited to this specific embodiment. It is appreciated that a person skilled in the relevant art knows how to program and implement the invention using any computer system.

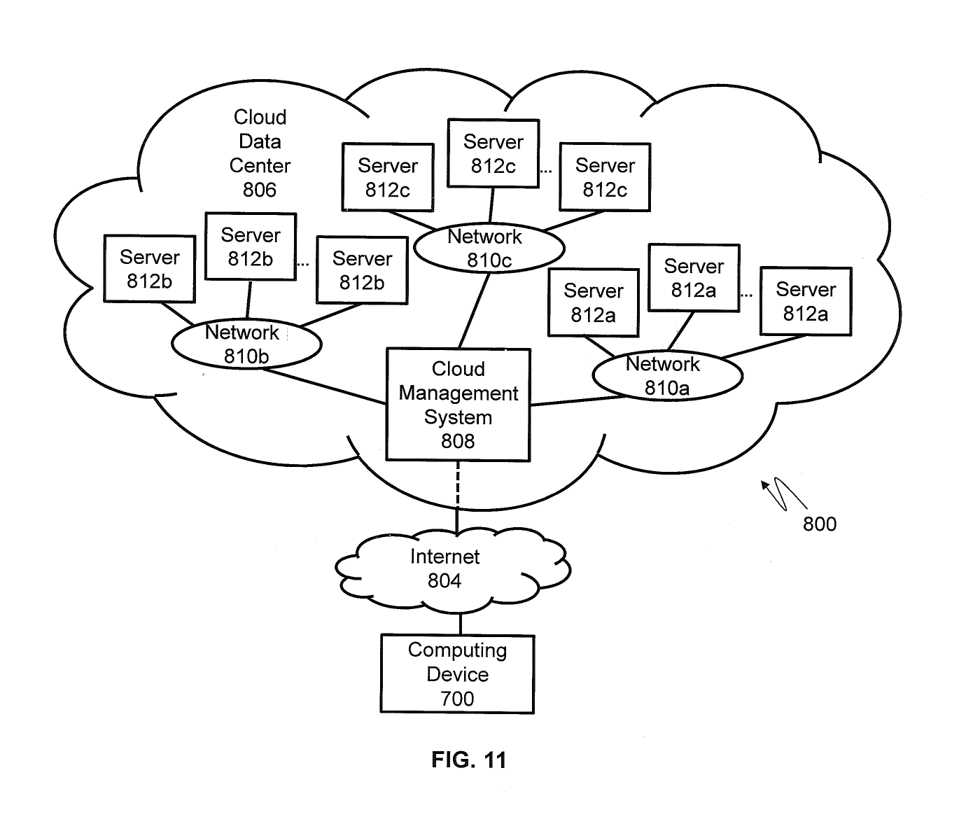

FIG. 11 illustrates an exemplary cloud computing system 800 that may be used to implement the methods according to the invention. The cloud computing system 800 includes a plurality of interconnected computing environments. The cloud computing system 800 utilizes the resources from various networks as a collective virtual computer, where the services and applications can run independently from a particular computer or server configuration making hardware less important.

Specifically, the cloud computing system 800 includes at least one computing device 700. The computing device 700 may be any device through the use of which a distributed computing environment may be accessed to perform the methods disclosed herein, for example, a traditional computer, portable computer, mobile phone, personal digital assistant, tablet to name a few. The computing device 700 includes memory such as random access memory (“RAM”), read-only memory (“ROM”), mass storage device, or any combination thereof. The memory functions as a computer usable storage medium, otherwise referred to as a computer readable storage medium, to store and/or access computer software and/or instructions.

The computing device 700 also includes a communications interface, for example, a modem, a network interface (such as an Ethernet card), a communications port, a PCMCIA slot and card, wired or wireless systems, etc. The communications interface allows communication through transferred signals between the computing device 700 and external devices including networks such as the Internet 804 and cloud data center 806. Communication may be implemented using wireless or wired capability such as cable, fiber optics, a phone line, a cellular phone link, radio waves or other communication channels.

The computing device 700 establishes communication with the Internet 804—specifically to one or more servers—to, in turn, establish communication with one or more cloud data centers 806. A cloud data center 406 includes one or more networks 810a, 810b, 810c managed through a cloud management system 808. Each network 810a, 810b, 810c includes resource servers 812a, 812b, 812c, respectively. Servers 812a, 812b, 812c permit access to a collection of computing resources and components that can be invoked to instantiate a virtual machine, process, or other resource for a limited or defined duration. For example, one group of resource servers can host and serve an operating system or components thereof to deliver and instantiate a virtual machine. Another group of resource servers can accept requests to host computing cycles or processor time, to supply a defined level of processing power for a virtual machine. A further group of resource servers can host and serve applications to load on an instantiation of a virtual machine, such as an email client, a browser application, a messaging application, or other applications or software.

The cloud management system 808 can comprise a dedicated or centralized server and/or other software, hardware, and network tools to communicate with one or more networks 810a, 810b, 810c, such as the Internet or other public or private network, with all sets of resource servers 812a, 812b, 812c. The cloud management system 408 may be configured to query and identify the computing resources and components managed by the set of resource servers 812a, 812b, 812c needed and available for use in the cloud data center 806. Specifically, the cloud management system 808 may be configured to identify the hardware resources and components such as type and amount of processing power, type and amount of memory, type and amount of storage, type and amount of network bandwidth and the like, of the set of resource servers 812a, 812b, 812c needed and available for use in the cloud data center 806. Likewise, the cloud management system 808 can be configured to identify the software resources and components, such as type of Operating System (“OS”), application programs, and the like, of the set of resource servers 812a, 812b, 812c needed and available for use in the cloud data center 806.

The invention is also directed to computer products, otherwise referred to as computer program products, to provide software to the cloud computing system 800. Computer products store software on any computer useable medium, known now or in the future. Such software, when executed, may implement the methods according to certain embodiments of the invention. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, Micro-Electro-Mechanical Systems (“MEMS”), nanotechnological storage device, etc.), and communication mediums (e.g., wired and wireless communications networks, local area networks, wide area networks, intranets, etc.). It is to be appreciated that the embodiments described herein may be implemented using software, hardware, firmware, or combinations thereof.

The cloud computing system 800 of FIG. 11 is provided only for purposes of illustration and does not limit the invention to this specific embodiment. It is appreciated that a person skilled in the relevant art knows how to program and implement the invention using any computer system or network architecture.

While the disclosure is susceptible to various modifications and alternative forms, specific exemplary embodiments of the invention have been shown by way of example in the drawings and have been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

1. A system for trading items by a consumer, comprising:
a processor;
a main memory in communication with the processor via a communication infrastructure and storing instructions that, when executed by the processor, cause the processor to:
obtain investing information;
generate a graphical representation of the investing information, wherein one or more actionable trade indicator is integrated in the graphical representation;
display the graphical representation in a user interface via a display unit;
permit selecting at least one of the one or more actionable trade indicators;
present a trade request form having one or more trade parameter input fields; and
automatically populate at least one or more trade parameter input fields based on selection of the at least one actionable trade indicator, thereby facilitating easy transfer of investing information into the trade request form.

2. The system of claim 1, wherein the main memory in communication with the processor via the communication infrastructure stores instructions that, when executed by the processor, cause the processor also to:
finalize trade request form; and
submit trade request form to a trading forum to possibly execute the trade as described in the trade request form.

3. The system of claim 1, wherein the graphical representation includes a past performance element configured to convey investing information regarding how certain one or more securities have performed during a time period.

4. The system of claim 1, wherein the graphical representation includes a predicted performance element configured to convey investing information regarding how certain one or more securities may performed in the future according to a prediction model and wherein the integrated actionable trade indicator is specifically integrated with the predicted performance element to facilitate easily perceiving any relationship between a trade parameter and predicted performance information.

5. The system of claim 4, wherein the prediction model is a pricing model selected from the group of:
rational pricing;
moneyness;
option time value; and
put-call parity.

6. The system of claim 4, wherein the main memory in communication with the processor via the communication infrastructure stores instructions that, when executed by the processor, cause the processor also to provide a settings component such that the consumer can choose which prediction model is employed to prepare the predicted performance element.

7. The system of claim 6, wherein the main memory in communication with the processor via the communication infrastructure stores instructions that, when executed by the processor, cause the processor also to provide a settings component such that the consumer can insert a hypothetical event into the prediction model.

8. The system of claim 1, wherein the main memory in communication with the processor via the communication infrastructure stores instructions that, when executed by the processor, cause the processor also to provide a settings component such that the consumer can pick a time frame for a performance element.

9. The system of claim 1, wherein the trade request form is configured to permit the consumer to manually enter trade parameter information.

10. The system of claim 1, wherein the trade request form is configured to permit the consumer to manually alter trade parameter information that was automatically populated into the trade parameter input fields of the trade request form.

11. The system of claim 1, wherein the graphical representation includes non-actionable indicators configured to form a graph, wherein the graph is comprised of an x-axis, a y-axis, and one or more plotted points.

12. The system of claim 11, wherein the x-axis is configured to represent time, the y-axis is configured to represent strike price for a trade, a first set of one or more plotted points are configured to represent the strike prices for past trades in a marketplace, and a second set of one or more plotted points are configured to represent likely strike prices in future trades, and wherein the second set of one or more plotted points are positioned to correspond to expiration date of a tradable derivative contract.

13. The system of claim 1, wherein the graphical representation includes at least one or more coded non-actionable indicators.

14. The system of claim 13, wherein the one or more coded non-actionable indicators include at least a first position indicator configured to illustrate a short position trading strategy and a second position indicator configured to illustrate a long position trading strategy.

15. The system of claim 1, wherein the presented trade request form is located such that at least part of the graphical representation is displayed simultaneously with the trade request form.

16. The system of claim 1, wherein the presented trade request form is located such that all of the graphical representation is displayed simultaneously with all of the trade request form.

17. The system of claim 1, wherein the main memory in communication with the processor via the communication infrastructure stores instructions that, when executed by the processor, cause the processor also to show a secondary information component configured to convey detailed investing information via the display unit.

18. The system of claim 1, wherein the investing information includes market information selected from earnings events, dividend events, news events, entity history, published trade analysis event, and hypothetical event.

19. The system of claim 1, wherein the graphical representation is configured as an infographic including at least two graphs.

20. The system of claim 1, wherein the graphical representation is configured to convey probability of a certain security reaching a certain price.
